(19) United States
(12) Patent Application Publication
(10) Pub. No.: US 2014/0278926 A1
(43) Pub. Date: Sep. 18, 2014

(54) SYSTEM AND METHOD FOR ATTRIBUTION OF MOBILE ADVERTISEMENTS RELATED TO MOBILE APPLICATIONS

(71) Applicant: IGT, Reno, NV (US)

(72) Inventors: John J. Close, Seattle, WA (US); Stacy A. Friedman, Beaverton, OR (US)

(73) Assignee: IGT, Reno, NV (US)

(21) Appl. No.: 13/827,437

(22) Filed: Mar. 14, 2013

(51) Int. Cl. G06Q 30/02

(52) U.S. Cl. CPC G06Q 30/0246
USPC 705/14.45

(57) ABSTRACT

In various embodiments, the present disclosure relates generally to a mobile advertising attribution system. The system enables the proper attribution of user interaction with mobile advertisement related to a mobile application after the user installs the mobile application. The system causes electronic devices to set cookies with advertisement campaign identifiers for advertisement campaigns including the mobile advertisements. When the mobile application is initially executed, the system receives the advertisement campaign identifiers, which enables advertising networks and the vendor of the mobile application to properly and accurately correlate which mobile advertisements are directly and indirectly responsible for the installation of the mobile application.

### COPYRIGHT NOTICE

A portion of the disclosure of this patent document contains or may contain material which is subject to copyright protection. The copyright owner has no objection to the photocopy reproduction of the patent document or the patent disclosure in exactly the form it appears in the Patent and Trademark Office patent file or records, but otherwise reserves all copyright rights whatsoever.

### BACKGROUND

Mobile advertising on smart phones and other electronic devices is becoming more prevalent as companies seek new ways to market their products and services to consumers. The electronic devices often display mobile advertisements on a webpage of a browser or within a mobile application. Many mobile advertisements are related to mobile applications, such as games, news, productivity, sports, etc., that are capable of execution on the electronic device, for example. When a user of an electronic device interacts with such a mobile advertisement, such as by touching or clicking the mobile advertisement, the electronic device accesses a mobile application store, such as the Apple App Store or Google Play, so that the mobile application can be downloaded and installed on the electronic device.

The mobile application store is informed of the mobile advertisement the user interacted with because the mobile application store was directly accessed due to the mobile advertisement. However, the mobile application store does not share or pass the mobile advertisement information through to the vendor of the mobile application. Therefore, when the mobile application is subsequently executed on the electronic device, the vendor of the mobile application does not know which mobile advertisement the user interacted with and cannot properly assign attribution of the mobile advertisement. In particular, the vendor cannot correlate the user interaction with the mobile advertisement with the installation of the mobile application, which can result in increased costs to the vendor.

Mobile advertising is typically sold by an advertising network to advertisers, such as vendors of mobile applications, under a cost per click model or a cost per install model. For the cost per cock model, advertisers pay an advertising network each time a mobile advertisement is clicked or interacted with. For the cost per install model, advertisers pay the advertising network for each installation of the mobile application related to the mobile advertisement. The rate under the cost per install model is generally much higher than the rate under the cost per click model. If the vendors of mobile applications do not know which mobile advertisements correlate to installations of the mobile applications, the vendors might not be purchasing advertising under the most optimal model.

For example, a vendor pays for advertising under the cost per click model to ten advertising networks, which results in 100,000 clicks of mobile advertisements and 20,000 installations of a mobile application. In this case, the vendor does not know which of the advertising networks is responsible for the installations but instead pays all of the advertising networks for the clicks of mobile advertisements. This may not be optimal if advertising on only some of the advertising networks is primarily responsible for the installations. It would be more beneficial and efficient to the vendor to advertise on those particular advertising networks so that their advertising budget is spent in a more targeted way.

Accordingly, there is a need to solve many of the above problems.

### SUMMARY

The present disclosure solves many of the above problems by providing a mobile advertising attribution system and method of operating the system. Generally, the system can be accessed from any suitable electronic device with a network connection, and the system enables the proper attribution of user interaction with mobile advertisements related to mobile applications. Various embodiments of the system of the present disclosure assist advertising networks and vendors of the mobile applications to accurately and properly correlate which mobile advertisements are directly and indirectly responsible for the installation of the mobile applications on electronic devices.

In various embodiments, the mobile advertising attribution system of the present disclosure is configured to: (1) receive from an electronic device an advertisement identifier associated with a mobile advertisement related to a mobile application; (2) determine an advertisement campaign identifier associated with the advertisement identifier that uniquely identifies an advertisement campaign including the mobile advertisement; (3) transmit a cookie set request including the advertisement campaign identifier and/or a date and time to the electronic device such that the electronic device sets a cookie including the advertisement campaign identifier and/or the date and time; (4) transmit a URL for a mobile application store such that the electronic device is redirected to the mobile application store; (5) store in a database the advertisement campaign identifier and/or the date and time for later association of the user interaction with the mobile advertisement with an initial execution of the mobile application; (6) receive from the electronic device the cookie including the advertisement campaign identifier and/or the date and time; and (7) store an attribution for the advertisement campaign in a database, in response to receiving the advertisement campaign identifier.

The system can also receive multiple advertisement campaign identifiers and/or dates and times from the cookie and can store one or more attributions for one or more advertisement campaigns. Various embodiments of the system are also configured to provide attribution to multiple advertisement campaigns on a weighted basis, and to analyze the timing and interaction between multiple mobile advertisements interacted with by the user to assist in determining the effectiveness of the advertisement campaigns. Thus, the system can determine the effectiveness of mobile advertisements and result in the placement of more of the effective mobile advertisements, and less of the less effective mobile advertisements. Based on this information, advertising networks can adjust their rates and pricing models to reflect the value of the mobile advertising on their networks, e.g., charging higher rates if their mobile advertisements have resulted in increased installations of the corresponding mobile applications, and vice versa. Moreover, advertisers can optimize their advertising and marketing efforts, such as by purchasing advertising under a cost per click model that is focused on the more effective advertising networks that result in proven installations of mobile applications. The system can be implemented using one or more servers and one or more databases.

Other objects, features and advantages of the present invention will be apparent from the following detailed disclosure, taken in conjunction with the accompanying sheets of drawings, wherein like reference numerals refer to like parts.

### BRIEF DESCRIPTION OF THE FIGURES

FIG. 1 is a schematic high level diagram of one example embodiment of a mobile application advertising attribution system of the present disclosure.

FIG. 2 is a schematic high level diagram of one example form of a computer or server of FIG. 1, having a memory element with a computer readable medium for implementing the system of FIG. 1 in one example embodiment of the mobile application advertising attribution system of the present disclosure.

FIG. 3 is a flowchart of an example process for operating a mobile advertising attribution system providing one embodiment of the present disclosure.

FIG. 4 is a flowchart of another example process for operating a mobile advertising attribution system providing another embodiment of the present disclosure.

FIG. 5 is a flowchart of an example process for operating an electronic device in a mobile advertising attribution system providing a further embodiment of the present disclosure.

FIG. 6 is a flowchart of another example process for operating an electronic device in a mobile advertising attribution system providing another embodiment of the present disclosure.

### DETAILED DESCRIPTION

Various embodiments of the mobile application advertising attribution system and method of the present disclosure are generally described herein. Generally, various embodiments of the system enable the accurate and proper attribution of user interaction with mobile advertisements related to a mobile application after the user installs the mobile application. Attribution of mobile advertisements includes the circumstances of how and when the user interacted with the mobile advertisements. The system therefore enables advertising networks and the vendor of the mobile application to correlate which mobile advertisements are directly and indirectly responsible for the installation of the mobile application.

In certain embodiments, the system receives from an electronic device an advertisement identifier associated with a mobile advertisement. The electronic device has displayed the mobile advertisement, which relates to a mobile application capable of executing on the electronic device. The system receives the advertisement identifier when a user of the electronic device has interacted with the mobile advertisement. In response to the received advertisement identifier, the system determines an advertisement campaign identifier that uniquely identifies an advertisement campaign including the mobile advertisement. The system transmits to the electronic device a cookie set request including the advertisement campaign identifier. The system transmits the cookie set request such that the electronic device sets a cookie including the advertisement campaign identifier and/or the date and time. The system can also transmit cookie attributes, such as an expiration date and time, as part of the cookie set request. The system further transmits to the electronic device a URL for a mobile application store so that the electronic device is redirected to visit the mobile application store for downloading and installing the mobile application. The system stores in the database the advertisement campaign identifier and/or the date and time for later association of the user interaction with the mobile advertisement with an initial execution of the mobile application.

The system subsequently receives from the electronic device the cookie including the advertisement campaign identifier and/or the date and time. The electronic device causes the mobile application, upon initial execution, to retrieve and transmit the advertisement campaign identifier and/or the date and time from the previously-set cookie. The system provides attribution to the advertisement campaign for the installation of the mobile application. The electronic device, in conjunction with the system, can update the status of the mobile application, such as by removing the cookie, marking the mobile application as used, and/or setting a dirty flag so that the electronic device does not cause the mobile application to access the cookie on later executions of the mobile application. The system enables accurate attribution of the installation of the mobile application with the advertisement campaign so that mobile application developers and advertising networks can properly allocate revenue.

In different embodiments, the system receives from an electronic device a first advertisement identifier associated with a first mobile advertisement related to a mobile application. In response to receiving the first advertisement identifier, the system determines a first advertisement campaign identifier, and transmits to the electronic device a cookie set request including the first advertisement campaign identifier. The system transmits the cookie set request such that the electronic device sets a cookie including the first advertisement campaign identifier and/or the date and time. The system also receives from the electronic device a second advertisement identifier associated with a second mobile advertisement related to the mobile application. In response to receiving the second advertisement identifier, the system determines a second advertisement campaign identifier, and transmits to the electronic device a cookie set request including a second advertisement campaign identifier. The system transmits the cookie set request such that the electronic device sets the cookie including the second advertisement campaign identifier and/or the date and time. The system can also transmit cookie attributes, such as an expiration date and time, as part of each of the cookie set requests. After transmitting each of the cookie set requests, the system also transmits to the electronic device a URL for a mobile application store so that the electronic device is redirected to visit the mobile application store for downloading and installing the mobile application. The system receives the first and second advertisement identification data when a user of the electronic device has respectively interacted with the first and second advertisements. The system stores in the database the advertisement campaign identifiers and/or the dates and times for later association of the user interaction with the mobile advertisement with an initial execution of the mobile application.

The system subsequently receives from the electronic device the cookie including the first and second advertisement campaign identifiers and/or the respective dates and times. The electronic device causes the mobile application, upon initial execution, to retrieve and transmit the first and second advertisement campaign identifiers and/or the dates and times from the previously-set cookie. The system provides attribution to the first and/or the second advertisement campaigns for the installation of the mobile application. The electronic device, in conjunction with the system, can update the status of the mobile application, such as by removing the cookie, marking the mobile application as used, and/or setting a dirty flag so that the electronic device does not cause the mobile application to access the cookie on later executions of the mobile application. The system enables accurate attribution of the installation of the mobile application with multiple mobile advertisements or advertisement campaigns so that mobile application developers and advertising networks can properly allocate revenue.

In various embodiments, the system receives from an electronic device multiple advertisement campaign identifiers and/or respective dates and times. The electronic device causes a mobile application, upon initial execution, to retrieve and transmit the advertisement campaign identifiers and/or the dates and times from a previously-set cookie. The multiple advertisement campaign identifiers have been previously included in the cookie when a user of the electronic device has interacted with multiple mobile advertisements that relate to the mobile application. The system provides attribution to the advertisement campaign including the mobile advertisement that the user last interacted with. The system can also provide attribution to multiple advertisement campaigns on a weighted basis, depending on the dates and times the user interacted with the respective mobile advertisements. The system analyzes the timing and interaction between the mobile advertisements interacted with by the user to assist in determining the effectiveness of the advertisement campaigns.

In other embodiments, the electronic device transmits to the system an advertisement identifier associated with a mobile advertisement. The electronic device has displayed the mobile advertisement, which relates to a mobile application capable of executing on the electronic device. The electronic device transmits the advertisement identifier when a user of the electronic device has interacted with the mobile advertisement. The electronic device receives from the system a cookie set request including an advertisement campaign identifier that uniquely identifies an advertisement campaign including the mobile advertisement. The electronic device sets a cookie including the advertisement campaign identifier and/or the date and time. The electronic device can also receive cookie attributes, such as an expiration date and time, as part of the cookie set request. The electronic device further receives from the system a URL for a mobile application store, and the electronic device is redirected to visit the mobile application store for downloading and installing the mobile application.

The electronic device transmits to the system the cookie including the advertisement campaign identifier and/or the date and time. The electronic device causes the mobile application, upon initial execution, to retrieve and transmit the advertisement campaign identifier and/or the date and time from the previously-set cookie. By transmitting the cookie to the system, the system is caused to store an attribution to the advertisement campaign for the installation of the mobile application. The electronic device, in conjunction with the system, can update the status of the mobile application, such as by removing the cookie, marking the mobile application as used, and/or setting a dirty flag so that the electronic device does not cause the mobile application to access the cookie on later executions of the mobile application.

In further embodiments, the electronic device transmits to the system an advertisement identifier associated with a mobile advertisement. The electronic device has displayed the mobile advertisement, which relates to a mobile application capable of executing on the electronic device. The electronic device transmits the advertisement identifier when a user of the electronic device has interacted with the mobile advertisement. The electronic device determines an advertisement campaign identifier associated with the advertisement identifier. The electronic device sets a cookie including the advertisement campaign identifier and/or the date and time. The electronic device can also set cookie attributes, such as an expiration date and time. The electronic device redirects to a mobile application store for downloading and installing the mobile application. The electronic device transmits to the system the cookie including the advertisement campaign identifier and/or the date and time. The electronic device causes the mobile application, upon initial execution, to retrieve and transmit the advertisement campaign identifier and/or the date and time from the previously-set cookie. By transmitting the cookie to the system, the system is caused to store an attribution to the advertisement campaign for the installation of the mobile application. The electronic device, in conjunction with the system, can update the status of the mobile application, such as by removing the cookie, marking the mobile application as used, and/or setting a dirty flag so that the electronic device does not cause the mobile application to access the cookie on later executions of the mobile application.

Referring now to the drawings and particularly to FIG. 1, one example embodiment of the mobile advertising attribution system of the present disclosure is generally illustrated and indicated by numeral 100. The mobile advertising attribution system 100 is configured to communicate with one or more electronic devices 150a, 150b, . . . 150z through a data network such as the internet. The system 100 is also configured to communicate with one or more advertisement servers 154 that supply mobile advertisements to the electronic devices. In certain embodiments, the system 100 includes the one or more advertisement servers 154 to supply the mobile advertisements to the electronic devices. The system 100 of the present disclosure includes one or more computers (such as one or more servers which include one or more processors and one or more memory devices which store databases) which execute the software, programs, instructions, utilities, modules, or other such components as further discussed herein. Various components of the system 100 may be implemented using software executable by one or more servers or computers, such as a computing device 200 with a processor 202 and memory 204 as shown in FIG. 2, which is described in more detail below.

The present disclosure contemplates that the electronic devices will include one or more computers (such as but not limited to desktop personal computers, laptop computers, smart phones, tablet computing devices, and personal digital assistants), as further discussed below. Users operate the electronic devices to browse web pages, utilize applications, communicate with other persons, and/or perform other tasks.

The advertisement server 154 transmits mobile advertisements through the data network to the electronic devices to be displayed on web pages, within applications, and/or otherwise displayed on the electronic devices. The mobile advertisements include banner advertisements, text advertisements, full-screen advertisements, and other types of advertisements. The content of the mobile advertisements includes text, graphics, video, sound, animation, and/or other elements. The mobile advertisements typically relate to products and services offered by companies or persons, including vendors and developers of mobile applications. The advertisement server 154 can transmit the mobile advertisements to the electronic devices over the network using HTML, Flash, or other appropriate languages and/or platforms. Each mobile advertisement includes an advertisement identifier for uniquely identifying the mobile advertisement. The advertisement identifier can include identifiers for the mobile advertisement itself, the advertising service or network, the product or service related to the mobile advertisement, the location of the mobile advertisement on the webpage or display, the type of electronic device on which the mobile advertisement is displayed, and/or other information. In some embodiments, the advertisement identifier can include identifiers that correspond to or can be translated into the above information. The advertisement identifier can also be a URL for the mobile advertisement.

When a user of the electronic device interacts with a mobile advertisement, the advertisement identifier is transmitted to the system 100, as further discussed below. The user interacts with a mobile advertisement by touching or clicking on the mobile advertisement on the electronic device. The mobile advertisements can be included as part of one or more advertisement campaigns. An advertisement campaign includes a series of mobile advertisements that are related, such as mobile advertisements for the same or similar products and services and/or having the same or similar themes. The advertisement campaign can be uniquely identified by an advertisement campaign identifier.

Advertisers utilizing mobile advertisements often want to know the effectiveness of the mobile advertisements as they relate to marketing their product or service. Such products and services can include mobile applications that are capable of execution on the electronic devices. The effectiveness is measured by the number of views (also known as impressions), the number of click-throughs of the mobile advertisements, and/or conversion rates (e.g., number of application installs). Advertisers can buy mobile advertisements based on these same metrics: views (cost per impression), click-throughs (cost per click), and/or installations (cost per install). For advertising networks and vendors of mobile applications, knowing the effectiveness of the mobile advertisements assists the vendors in controlling costs related to installations of the mobile applications. In particular, proper and accurate attribution of user interaction with mobile advertisements related to mobile applications will enable the advertising networks and vendors to correlate which mobile advertisements are directly and indirectly responsible for the installations of the mobile applications. Accordingly, the vendors can focus their advertising purchasing on the advertising networks that are more likely to result in installations of the mobile applications.

The electronic devices can access an application store 152 through the data network to download and install mobile applications. The application store 152 includes, for example, the Apple App Store, Google Play, and other application stores. Because electronic devices must typically utilize the application store 152 to download and install mobile applications, the application store 152 serves as a centralized distribution location for the mobile applications. In other words, the electronic devices do not access the websites or internet sites of the vendors of the mobile applications to download and install the mobile applications. Mobile applications are available for free or at a cost paid by a user. For paid applications, the application store 152 typically retains a portion of the cost paid by the user, with the remainder going to the vendor of the mobile application.

The mobile advertising attribution system 100 is further illustrated in an example system configuration of one example embodiment in FIG. 1. In this example embodiment, the system 100 is configured to enable the proper attribution of user interactions with mobile advertisements related to mobile applications. The system 100 includes an advertisement campaign attribution engine 102 for managing the attribution of user interactions with mobile advertisements, an advertisement campaign attribution analysis engine 104 for analyzing the timing, order, and interaction of the user interactions with the mobile advertisements, and a database 106 for storing advertisement identifiers, advertisement campaign identifiers, dates and times, analytics, and other data.

The advertisement campaign attribution engine 102 receives through the data network from an electronic device an advertisement identifier associated with a mobile advertisement. In response, the engine 102 transmits a cookie set request through the data network to the electronic device with an advertisement campaign identifier and/or a date and time so that the electronic device sets a cookie with this information. The mobile advertisement can be related to a mobile application capable of executing on the electronic device, and can be included as part of an advertisement campaign identified by the advertisement campaign identifier. The engine 102 also transmits a URL for a mobile application store through the data network to the electronic device so that the electronic device is redirected to the mobile application store to download and install the mobile application. In some embodiments, the electronic device sets a cookie with the advertisement campaign identifier and/or the date and time without receiving a cookie set request from the server, and also redirects to the mobile application store without receiving a URL from the server. In this case, the electronic device sets the cookie and redirects to the mobile application store using client-side scripting, which is described in more detail below. The engine 102 stores in the database 106 the advertisement campaign identifier and the date and time for later association of the user interaction with the mobile advertisement with an initial execution of the mobile application.

The engine 102 subsequently receives a cookie through the data network from the electronic device that includes the advertisement campaign identifier and/or a date and time. The cookie can be stored in a browser on the electronic device or a data store on the electronic device. In some embodiments, the mobile application can act as a browser, such as by handling HTTP requests to and from the system 100, storing and removing cookies, and other browser functionality. The electronic device transmits the cookie to the engine 102 after the electronic device has executed the mobile application for the first time. The engine 102 stores an attribution in the database 106 for the advertisement campaign identified by the received advertisement campaign identifier, in response to receiving the advertisement campaign identifier. The engine 102 causes the electronic device to update the status of the mobile application, such as by removing the previously-set cookie or marking the mobile application as used, and/or in some embodiments, to set a dirty flag in the mobile application so that the electronic device does not transmit the cookie in future executions of the mobile application. In this way, the system 100 and the engine 102 can ensure the installation of the mobile application is properly attributed to the mobile advertisement (and the advertisement campaign) that the user interacted with.

If multiple advertisement campaign identifiers are included in the cookie received by the engine 102, the engine 102 can store an attribution in the database 106 for the advertisement campaign including the mobile advertisement the user most recently interacted with. In certain embodiments, if multiple advertisement campaign identifiers are included in the cookie received by the engine 102, the engine 102 can store attributions in the database 106 for multiple advertisement campaigns on a weighted basis, such as dependent on the dates and times or order the user interacted with the respective mobile advertisements. The engine 102 can utilize the advertisement campaign attribution analysis engine 104 to determine the multiple attributions, in this case. The advertisement campaign attribution analysis engine 104 can also perform a correlation analysis to analyze the timing, order, and interaction between the mobile advertisements interacted with by the user. The correlation analysis can assist in determining the effectiveness of the advertisement campaigns. The engine 104 stores such analytics in the database 106 for use by marketing personnel.

As an example, the advertisement server 154 transmits a first mobile advertisement and a second mobile advertisement to the electronic devices. The response rate for users who interacted with only the second mobile advertisement before installing the mobile application may be 16%, but the response rate for users who interacted with the first mobile advertisement then the second mobile advertisement before installing the mobile application may be 35%, for example. In this case, the correlation analysis between the mobile advertisements determines that the second mobile advertisement is more effective in obtaining installations of the mobile application when preceded by the first mobile advertisement.

FIG. 2 is a block diagram of a computing device 200 housing executable software used to facilitate the mobile advertising attribution system 100. One or more instances of the computing device 200 can be utilized to implement any, some, or all of the components in the system 100, including the advertisement campaign attribution engine 102 and the advertisement campaign attribution analysis engine 104. Computing device 200 includes a memory element 204. Memory element 204 can include a computer readable medium for implementing the system 100, and for implementing particular system transactions. Memory element 204 can also be utilized to implement the database 106. Computing device 200 also contains executable software, some of which may or may not be unique to the system 100.

In some embodiments, the system 100 is implemented in software, as an executable program, and is executed by one or more special or general purpose digital computer(s), such as a mainframe computer, a personal computer (desktop, laptop or otherwise), personal digital assistant, or other handheld computing device. Therefore, computing device 200 may be representative of any computer in which the system 100 resides or partially resides.

Generally, in terms of example hardware architecture as shown in FIG. 2, computing device 200 includes a processor 202, a memory 204, and one or more input and/or output (I/O) devices 206 (or peripherals) that are communicatively coupled via a local interface 208. Local interface 208 can be one or more buses or other wired or wireless connections, as is known in the art. Local interface 208 can have additional elements, which are omitted for simplicity, such as controllers, buffers (caches), drivers, transmitters, and receivers to facilitate external communications with other like or dissimilar computing devices. Further, local interface 208 can include address, control, and/or data connections to enable internal communications among the other computer components.

Processor 202 includes a hardware device for executing software, particularly software stored in memory 204. Processor 202 can include any custom made or commercially available processor, such as, for example, a Core series or vPro processor made by Intel Corporation, or a Phenom, Athlon or Sempron processor made by Advanced Micro Devices, Inc. In the case where computing device 200 is a server, the processor can be, for example, a Xeon or Itanium processor from Intel, or an Opteron-series processor from Advanced Micro Devices, Inc. Processor 202 can also represent multiple parallel or distributed processors working in unison.

Memory 204 can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). It can incorporate electronic, magnetic, optical, and/or other types of storage media. Memory 204 can have a distributed architecture where various components are situated remote from one another, but are still accessed by processor 202. These other components can reside on devices located elsewhere on a network or in a cloud arrangement.

The software in memory 204 can include one or more separate programs. The separate programs comprise ordered listings of executable instructions for implementing logical functions. In the example of FIG. 2, the software in memory 204 can include the system 100 in accordance with the invention, and a suitable operating system (O/S) 212. Examples of suitable commercially available operating systems 212 are Windows operating systems available from Microsoft Corporation, Mac OS X available from Apple Computer, Inc., a Unix operating system from AT&T, or a Unix-derivative such as BSD or Linux. The operating system O/S 212 will depend on the type of computing device 200. For example, if the computing device 200 is a PDA or handheld computer, the operating system 212 can be iOS for operating certain devices from Apple Computer, Inc., PalmOS for devices from Palm Computing, Inc., Windows Phone 8 from Microsoft Corporation, Android from Google, Inc., or Symbian from Nokia Corporation. Operating system 212 essentially controls the execution of other computer programs, such as the system 100, and provides scheduling, input-output control, file and data management, memory management, and communication control and related services.

If computing device 200 is an IBM PC compatible computer or the like, the software in memory 204 can further include a basic input output system (BIOS). The BIOS is a set of essential software routines that initialize and test hardware at startup, start operating system 212, and support the transfer of data among the hardware devices. The BIOS is stored in ROM so that the BIOS can be executed when computing device 200 is activated.

Steps and/or elements, and/or portions thereof of the invention can be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, and Lua. Components of the system 100 can also be written in a proprietary language developed to interact with these known languages.

I/O device 206 can include input devices such as a keyboard, a mouse, a scanner, a microphone, a touch screen, a bar code reader, or an infra-red reader. It can also include output devices such as a printer, a video display, an audio speaker or headphone port or a projector. I/O device 206 can also comprise devices that communicate with inputs or outputs, such as a short-range transceiver (RFID, Bluetooth, etc.), a telephonic interface, a cellular communication port, a router, or other types of network communication equipment. I/O device 206 can be internal to computing device 200, or can be external and connected wirelessly or via connection cable, such as through a universal serial bus port. A video display or other display device can be any suitable type of display devices such as but not limited to a conventional computer monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image.

When computing device 200 is in operation, processor 202 is configured to execute software stored within memory 204, to communicate data to and from memory 204, and to generally control operations of computing device 200 pursuant to the software. The system 100 and operating system 212, in whole or in part, can be read by processor 202, buffered within processor 202, and then executed.

In the context of this document, a “computer-readable medium” can be any mechanism that can store, communicate, propagate, or transport data objects for use by or in connection with the system 100. The computer readable medium can be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The system 100 can be embodied in any type of computer-readable medium for use by or in connection with an instruction execution system or apparatus, such as a computer.

It should further be appreciated that the system 100 will communicate with the electronic devices and other computing devices through any suitable wired, partially wired, or wireless data network. Thus, it should be appreciated that the system of the present disclosure can operate through any suitable central or remote network such as but not limited to a local area network (LAN), a wide area network (WAN), an intranet, and the internet (such as through cloud computing). For purposes of connecting to other computing devices, computing device 200 is equipped with network communication equipment and circuitry. In an embodiment, the network communication equipment includes a network card such as an Ethernet card, or a wireless connection card. In a network environment, each of the plurality of computing devices 200 on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while an embodiment of the invention is for each computing device 200 to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks.

It should be appreciated that the electronic devices 150a, 150b, . . . 150z also include one or more processors, one or more memory devices, one or more display devices, one or more input devices, and one or more piece of network communication equipment. Similar to the computing device 200, the processors, memory devices, display devices, input devices, and network communication equipment of the electronic devices can be any of those devices as described above.

Referring now to FIG. 3, a flowchart of an example embodiment of a process for operating a mobile advertising attribution system 100 disclosed herein is illustrated. In one embodiment, this process is embodied in one or more software programs stored in one or more memories and executed by one or more processors or servers, as described above. Although this process is described with reference to the flowchart illustrated in FIG. 3, it should be appreciated that many other methods of performing the acts associated with this process may be used. For example, the order of certain steps described may be changed, or certain steps described may be optional.

In one embodiment, the advertisement server 154 and/or the system 100 transmits to an electronic device a mobile advertisement related to a mobile application as indicated in block 302 of FIG. 3. The mobile application is typically executable by the electronic device so that the mobile advertisement is intended to market the mobile application to a user of the electronic device. The mobile advertisement includes an advertisement identifier for uniquely identifying the mobile advertisement. The advertisement identifier can include identifiers for the advertising service and/or the product or service related to the mobile advertisement. The advertisement server 154 and/or the system 100 transmits the mobile advertisement to the electronic device over a network using HTML, Flash, or other appropriate languages, protocols, and/or platforms. The electronic device displays the mobile advertisement to a user of the electronic device on a web page or within an application, for example. The content of the mobile advertisement includes text, graphics, video, sound, animation, and/or other elements, and can be arranged as a banner advertisement, text advertisement, full-screen advertisement, or other type of advertisement.

When the user interacts with the mobile advertisement, the advertisement identifier for the mobile advertisement is transmitted from the electronic device and received by the system 100, as indicated in block 304. The user interacts with the mobile advertisement by touching or clicking on the mobile advertisement on the electronic device, for example. In one embodiment, the advertisement identifier can be transmitted to the system 100 through URL query strings and parameters, such as through HTTP GET (e.g., transmitting the URL and a header), HTTP POST (e.g., transmitting a message body), and/or HTTP PUT requests, and/or through custom or proprietary protocols. This is in contrast to traditional interaction with a mobile advertisement related to a mobile application, which immediately directs the electronic device to an application store for downloading and installation of the mobile application.

The system 100 queries the database 106 with the received advertisement identifier to determine the validity of the advertisement identifier, as indicated in block 306. The system 100 also queries the database 106 with the received advertisement identifier for purposes of determining an association of the mobile advertisement with an advertisement campaign. The database 106 includes advertisement identifiers for any number of mobile advertisements, and includes advertisement campaign identifiers for uniquely identifying any number of advertisement campaigns. An advertisement campaign can include one or more mobile advertisements that are related to the same mobile application. Similarly, a mobile advertisement related to a mobile application can be included as part of one or more advertisement campaigns. Accordingly, the database 106 can include cross-references between the advertisement identifiers and the advertisement campaign identifiers to match up the advertisement identifiers and the advertisement campaign identifiers. In one embodiment, the advertisement identifiers and the advertisement campaign identifiers have been previously obtained from the advertisement server 154. The advertising networks, the vendor of the mobile applications, and/or other entities can create the advertisement identifiers and the advertisement campaign identifiers. In some embodiments, the advertisement identifiers and the advertisement campaign identifiers are configured such that particular functionality is enabled or activated for marketing or other purposes.

After querying the database 106 with the received advertisement identifier, the system 100 determines if the advertisement identifier is valid as indicated in diamond 308. In one embodiment, an error message is returned from the database 106 to the system 100 in response to the query, if the advertisement identifier is not valid, such as if the advertisement identifier is not in the database 106 or if the advertisement identifier is otherwise invalid. If the advertisement identifier is not valid, the system 100 can return to receive advertisement identifiers for mobile advertisements that are interacted with in the future, as indicated in block 304.

However, if the advertisement identifier is valid, the system 100 receives from the database 106 an advertisement campaign identifier associated with the advertisement identifier, as indicated in block 310. In one embodiment, the advertisement campaign identifier is returned from the database 106 to the system 100 in response to the query, if the advertisement identifier is valid. The advertisement identifier is valid if the advertisement identifier is in the database 106 and its associated mobile advertisement is included as part of an advertisement campaign. The advertisement campaign identifier uniquely identifies the advertisement campaign, and can include identifiers for the advertising service and/or the product or service related to the mobile advertisements included in the advertisement campaign.

The system 100 stores the advertisement campaign identifier, the date and time the advertisement identifier was received from the electronic device, and/or other information in the database 106, as indicated in block 312. Other information can be stored in the database 106, such as the IP address of the electronic device, the geographic location of the electronic device, the type of the electronic device, and/or other information. This information is stored for later association of the user interaction with the mobile advertisement with an initial execution of the mobile application on the electronic device. In one embodiment, the system 100 stores this information in one or more log files in the database 106. In some embodiments, the date and time the advertisement identifier is received can be compared to the date and time the mobile application is initially executed to more accurately detect that the execution of the mobile application is correlated with the corresponding mobile advertisement. For example, the date and time the mobile application is initially executed could be required to be within a certain timeframe, e.g., one week, of the date and time the advertisement identifier is received.

The system 100 transmits a cookie set request to the electronic device to cause the electronic device to set a cookie including the advertisement campaign identifier, the date and time, cookie attributes, and/or other information, as indicated in block 314. The cookie can be set in a browser on the electronic device and/or in a data store of the electronic device that is capable of storing, retrieving, and removing cookies without the use of a browser. In one embodiment, an application that implements behavior similar to a browser executes on the electronic device to store, retrieve, and remove the cookie in the data store. The cookie set request can be formed as part of an HTTP response that requests the electronic device to set a name-value pair for each of the advertisement campaign identifier, the date and time, and/or other information. In one embodiment, the date and time includes the date and time the advertisement identifier was received by the system 100. In another embodiment, the date and time includes the date and time the cookie set request is being transmitted to the electronic device. The cookie set request can request the electronic device to set cookie attributes including a cookie domain, a path, an expiration date and time, a maximum age, a Secure flag, and/or an HttpOnly flag. In particular, an expiration date and time or a maximum age can be transmitted in the cookie set request so that the cookie is a persistent cookie that will remain in the electronic device, in contrast to a session cookie that is deleted, such as after a browser is closed. In one embodiment, the cookie set request causes the electronic device to set the cookie as a background process so that the user of the electronic device does not visually see a browser opening if the browser was not already open, e.g., if the mobile advertisement was displayed in an application. In another embodiment, the cookie set request causes the electronic device to set the cookie such that the browser momentarily opens on the electronic device.

After transmitting the cookie set request, the system 100 transmits a uniform resource locator (URL) for an application store 152 to the electronic device, as indicated in block 316. The electronic device is redirected to the application store 152 to download and install the mobile application related to the mobile advertisement that the user interacted with. The application store 152 includes, for example, the Apple App Store, Google Play, and other application stores. The URL for the application store 152 could cause the electronic device to execute a dedicated application for the mobile application store or to open a web page corresponding to the mobile application store.

An originating URL is the URL of the resource that led to access of another resource. In one embodiment, the originating URL to the application store 152 can be specified as the URL of the mobile advertisement and can be transmitted by the electronic device to the application store 152. In another embodiment, the originating URL can be changed to be the URL of the system 100 on the network and the URL of the system 100 can be transmitted by the electronic device to the application store 152. The user of the electronic device can download and install the mobile application, or can choose not to download and install the mobile application. Installing the mobile application includes granting the appropriate permissions to use the mobile application on the electronic device, in one embodiment. If the user chooses not to download and install the mobile application, the previously-set cookie will still remain on the electronic device.

If the user has downloaded and installed the mobile application, then upon initial execution of the mobile application, the mobile application can invoke and execute the browser on the electronic device to retrieve the previously-set cookie, or cause another application to retrieve the cookie from the data store on the electronic device. The electronic device can transmit the cookie and its associated data, and the system 100 can receive the cookie and its associated data, as indicated in block 318. The associated data in the cookie transmitted to the system 100 includes the advertisement campaign identifier, the date and time, and/or other information in the cookie. In one embodiment, the initial execution of the mobile application causes the electronic device to retrieve the cookie as a background process so that the user of the electronic device does not visually see the browser opening. In another embodiment, the initial execution of the mobile application causes the electronic device to retrieve the cookie such that the browser is momentarily seen on the electronic device. It should be noted that the mobile application is configured to retrieve the previously-set cookie upon initial execution by invoking and executing the browser and/or causing another application to retrieve the cookie from a data store. The vendor of the mobile application can configure the mobile application to perform this task.

After receiving the cookie, the system 100 determines if the advertisement campaign identifier is valid, as indicated in diamond 320. To determine the validity of the advertisement campaign identifier, the system 100 queries the database 106 to determine if the advertisement campaign identifier exists in the database 106, such as if the advertisement campaign identifier was stored in a log file, as in block 312. If the advertisement campaign identifier is not valid, the system 100 can return to receive cookies when mobile applications are initially executed in the future, as indicated in block 318.

However, if the advertisement campaign identifier is valid, the system 100 stores an attribution in the database 106 for the advertisement campaign based on the advertisement campaign identifier, as indicated in block 322. The attribution associates the prior user interaction with a mobile advertisement of the advertisement campaign with the initial execution of the mobile application related to the mobile advertisement. In this way, the advertising network and the vendor of the mobile application can determine more effectively and accurately which mobile advertisements and/or advertisement campaigns are directly and indirectly responsible for the installation and initial execution of their mobile applications.

In one embodiment, after the attribution is stored, the system 100 can cause the electronic device to update the status of the electronic device, such as by removing the previously-set cookie, marking the mobile application as used, and/or setting a dirty flag so that the electronic device does not cause the mobile application to access the cookie on later executions of the mobile application, as indicated in block 324. To remove the previously-set cookie, the system 100 can transmit a cookie set request for the previously-set cookie with an expiration date prior to the current date and time. The system 100 can also transmit as part of the cookie set request blank or different data for the previously-set name-value pairs in the cookie. In these cases, for example, the electronic device visits a URL on the system 100 that is only accessed when the mobile application is initially executed and in response, the system 100 transmits the cookie set request to remove the cookie, as described above. In one embodiment, to set a dirty flag in the mobile application, the system 100 can transmit a request to the mobile application on the electronic device. In another embodiment, the mobile application can be previously configured by the vendor to set the dirty flag after an initial execution of the mobile application. The mobile application can also be configured by the vendor to remove the previously-set cookie, in some embodiments.

Referring now to FIG. 4, a flowchart of another example embodiment of a process for operating a mobile advertising attribution system 100 disclosed herein is illustrated. In one embodiment, this process is embodied in one or more software programs stored in one or more memories and executed by one or more processors or servers, as described above. Although this process is described with reference to the flowchart illustrated in FIG. 4, it should be appreciated that many other methods of performing the acts associated with this process may be used. For example, the order of certain steps described may be changed, or certain steps described may be optional.

In this example embodiment, a user interacts with multiple mobile advertisements related to the mobile application prior to an initial execution of the mobile application. Separate cookie set requests are transmitted to the electronic device from the system for each received advertisement identifier. When the mobile application is initially executed, multiple advertisement campaign identifiers and dates and times can be received, which can result in more than one attribution of the installation of the mobile application to an advertisement campaign, as described further below. The mobile advertisements, advertisement identifiers, and/or advertisement campaign identifiers can be the same or different.

In one embodiment, the advertisement server 154 and/or the system 100 transmits to an electronic device a mobile advertisement related to a mobile application as indicated in block 402 of FIG. 4. The mobile application is typically executable by the electronic device so that the mobile advertisement is intended to market the mobile application to a user of the electronic device. The mobile advertisement includes an advertisement identifier for uniquely identifying the mobile advertisement. The advertisement identifier can include identifiers for the advertising service and/or the product or service related to the mobile advertisement. The advertisement server 154 and/or the system 100 transmits the mobile advertisement to the electronic device over a network using HTML, Flash, or other appropriate languages, protocols, and/or platforms. The electronic device displays the mobile advertisement to a user of the electronic device on a web page or within an application, for example. The content of the mobile advertisement includes text, graphics, video, sound, animation, and/or other elements, and can be arranged as a banner advertisement, text advertisement, full-screen advertisement, or other type of advertisement.

When the user interacts with the mobile advertisement, the advertisement identifier for the mobile advertisement is transmitted from the electronic device and received by the system 100, as indicated in block 404. The user interacts with the mobile advertisement by touching or clicking on the mobile advertisement on the electronic device, for example. In one embodiment, the advertisement identifier can be transmitted to the system 100 through URL query strings and parameters. In one embodiment, the advertisement identifier can be transmitted to the system 100 through URL query strings and parameters, such as through HTTP GET (e.g., transmitting the URL and a header), HTTP POST (e.g., transmitting a message body), and/or HTTP PUT requests, and/or through custom or proprietary protocols. This is in contrast to traditional interaction with a mobile advertisement related to a mobile application, which immediately directs the electronic device to an application store for downloading and installation of the mobile application.

The system 100 queries the database 106 with the received advertisement identifier to determine the validity of the advertisement identifier, as indicated in block 406. The system 100 also queries the database 106 with the received advertisement identifier for purposes of determining an association of the mobile advertisement with an advertisement campaign. The database 106 includes advertisement identifiers for any number of mobile advertisements, and includes advertisement campaign identifiers for uniquely identifying any number of advertisement campaigns. An advertisement campaign can include one or more mobile advertisements that are related to the same mobile application. Similarly, a mobile advertisement related to a mobile application can be included as part of one or more advertisement campaigns. Accordingly, the database 106 can include cross-references between the advertisement identifiers and the advertisement campaign identifiers to match advertisement identifiers and advertisement campaign identifiers. In one embodiment, the advertisement identifiers and the advertisement campaign identifiers have been previously obtained from the advertisement server 154.

After querying the database 106 with the received advertisement identifier, the system 100 determines if the advertisement identifier is valid as indicated in diamond 408. In one embodiment, an error message is returned from the database 106 to the system 100 in response to the query, if the advertisement identifier is not valid, such as if the advertisement identifier is not in the database 106 or if the advertisement identifier is otherwise invalid. If the advertisement identifier is not valid, the system 100 can return to receive advertisement identifiers for mobile advertisements that are interacted with in the future, as indicated in block 404.

However, if the advertisement identifier is valid, the system 100 receives from the database 106 an advertisement campaign identifier associated with the advertisement identifier, as indicated in block 410. In one embodiment, the advertisement campaign identifier is returned from the database 106 to the system 100 in response to the query, if the advertisement identifier is valid. The advertisement identifier is valid if the advertisement identifier is in the database 106 and its associated mobile advertisement is included as part of an advertisement campaign. The advertisement campaign identifier uniquely identifies the advertisement campaign, and can include identifiers for the advertising service and/or the product or service related to the mobile advertisements included in the advertisement campaign.

The system 100 stores the advertisement campaign identifier, the dare and time the advertisement identifier was received from the electronic device, and/or other information in the database 106, as indicated in block 412. This information is stored for later association of the user interaction with the mobile advertisement with an initial execution of the mobile application on the electronic device. In one embodiment, the system 100 stores this information in one or more log files in the database 106.

The system 100 transmits a cookie set request to the electronic device to cause the electronic device to set a cookie including the advertisement campaign identifier, the date and time, cookie attributes, and/or other information, as indicated in block 414. The cookie can be set in a browser on the electronic device and/or in a data store of the electronic device that is capable of storing, retrieving, and removing cookies without the use of a browser. In one embodiment, an application that implements behavior similar to a browser executes on the electronic device to store the cookie in the data store. The cookie set request can be formed as part of an HTTP response that requests the electronic device to set a name-value pair for each of the advertisement campaign identifier, the date and time, and/or other information. In one embodiment, the date and time includes the date and time the advertisement identifier was received by the system 100. In another embodiment, the date and time includes the date and time the cookie set request is being transmitted to the electronic device. The cookie set request can request the electronic device to set cookie attributes including a cookie domain, a path, an expiration date and time, a maximum age, a Secure flag, and/or an HttpOnly flag. In particular, an expiration date and time or a maximum age can be transmitted in the cookie set request so that the cookie is a persistent cookie that will remain in the electronic device, in contrast to a session cookie that is deleted, such as after a browser is closed. In one embodiment, the cookie set request causes the electronic device to set the cookie as a background process so that the user of the electronic device does not visually see a browser opening if the browser was not already open, e.g., if the mobile advertisement was displayed in an application. In another embodiment, the cookie set request causes the electronic device to set the cookie such that the browser momentarily opens on the electronic device.

After transmitting the cookie set request, the system 100 transmits a uniform resource locator (URL) for an application store 152 to the electronic device, as indicated in block 416. The electronic device is redirected to the application store 152 to download and install the mobile application related to the mobile advertisement that the user interacted with. The application store 152 includes, for example, the Apple App Store, Google Play, and other application stores. The URL for the application store 152 could cause the electronic device to execute a dedicated application for the mobile application store or to open a web page corresponding to the mobile application store.

An originating URL is the URL of the resource that led to access of another resource. In one embodiment, the originating URL to the application store 152 can be specified as the URL of the mobile advertisement and can be transmitted by the electronic device to the application store 152. In another embodiment, the originating URL can be changed to be the URL of the system 100 on the network and the URL of the system 100 can be transmitted by the electronic device to the application store 152. The user of the electronic device can download and install the mobile application, or can choose not to download and install the mobile application. Installing the mobile application includes granting the appropriate permissions to use the mobile application on the electronic device, in one embodiment. If the user chooses not to download and install the mobile application, the cookie previously set will still remain on the electronic device.

In this example embodiment, a user interacts with multiple mobile advertisements related to the mobile application prior to an initial execution of the mobile application, resulting in the system 100 receiving multiple advertisement identifiers at block 404. Each of the multiple mobile advertisements and corresponding advertisement identifiers may be the same or different. With each received advertisement identifier, the system 100 receives and stores an advertisement campaign identifier and corresponding date and time in the database 106 at blocks 410 and 412. There may be one or more advertisement campaign identifiers that correspond to the mobile advertisements, and each of the advertisement campaign identifiers may be the same or different. In addition, the system 100 transmits separate cookie set requests to the electronic device to set a cookie in the electronic device for each of the advertisement campaign identifiers and dates and times at block 414. In one embodiment, a single cookie is set in the electronic device that includes the multiple advertisement campaign identifiers and dates and times. In another embodiment, multiple cookies are set in the electronic device that each includes some of the multiple advertisement campaign identifiers and dates and times.

If the user has downloaded and installed the mobile application, then upon initial execution of the mobile application, the mobile application can invoke and execute the browser on the electronic device to retrieve the previously-set cookie(s), or cause another application to retrieve the cookie(s) from the data store on the electronic device. The electronic device can transmit the cookie(s) and their associated data, and the system 100 can receive the cookie(s) and its associated data, as indicated in block 418. The associated data in the cookie(s) transmitted to the system 100 includes the multiple advertisement campaign identifiers, the dates and times, and/or other information in the cookie. In one embodiment, the initial execution of the mobile application causes the electronic device to retrieve the cookie(s) as a background process so that the user of the electronic device does not visually see the browser opening. In another embodiment, the initial execution of the mobile application causes the electronic device to retrieve the cookie(s) such that the browser is momentarily seen on the electronic device. It should be noted that the mobile application is configured to retrieve the previously-set cookie(s) upon initial execution by invoking and executing the browser and/or causing another application to retrieve the cookie from a data store. The vendor of the mobile application can configure the mobile application to perform this task.

After receiving the cookie(s), the system 100 determines if the advertisement campaign identifiers are valid, as indicated in diamond 420. To determine the validity of the advertisement campaign identifiers, the system 100 queries the database 106 to determine if the advertisement campaign identifiers exist in the database 106, such as if the advertisement campaign identifiers were stored in a log file, as in block 412. If the advertisement campaign identifiers are not valid, the system 100 can return to receive cookies when mobile applications are initially executed in the future, as indicated in block 418.

However, if the advertisement campaign identifiers are valid, the system 100 stores one or more attributions in the database 106 for the advertisement campaigns based on the advertisement campaign identifiers, as indicated in block 422. The attribution associates the prior user interaction with mobile advertisements of the advertisement campaign(s) with the initial execution of the mobile application related to the mobile advertisements. In this way, the advertising network and the vendor of the mobile application can determine more effectively and accurately which mobile advertisements and/or advertisement campaigns are directly and indirectly responsible for the installation and initial execution of their mobile applications. The attributions can be stored in the database 106 based on chronological order and/or weighting of the advertisement campaign identifiers in the cookie(s). In one embodiment, the advertisement campaign including the mobile advertisement that was most recently interacted with by the user will receive attribution. In another embodiment, the advertisement campaigns within a certain recent time period will receive equal or weighted attribution. In a further embodiment, all of the advertisement campaigns will receive equal or weighted attribution. In another embodiment, the attribution for the advertisement campaigns can be based on a correlation analysis of the interaction, order, and/or timing of how the mobile advertisements were interacted with by the user. The correlation analysis can be utilized by the advertising network and the vendor of the mobile application to direct future advertisement and marketing strategies. Such strategies may include determining which advertising networks to purchase mobile advertisements on, determining rates for mobile advertisements, and/or other strategies.

In one embodiment, after the attribution(s) are stored, the system 100 can cause the electronic device to update the status of the electronic device, such as by removing the previously-set cookie(s), marking the mobile application as used, and/or setting a dirty flag so that the electronic device does not cause the mobile application to access the browser on later executions of the mobile application, as indicated in block 424. To remove the previously-set cookie(s), the system 100 can transmit cookie set requests for the previously-set cookie(s) with expiration dates prior to the current date and time. The system 100 can also transmit as part of the cookie set requests blank or different data for the previously-set name-value pairs in the cookies. In these cases, for example, the electronic device visits a URL on the system 100 that is only accessed when the mobile application is initially executed and in response, the system 100 transmits the cookie set request to remove the cookie, as described above. In one embodiment, to set a dirty flag in the mobile application, the system 100 can transmit a request to the mobile application on the electronic device. In another embodiment, the mobile application can be previously configured by the vendor to set the dirty flag after an initial execution of the mobile application. The mobile application can also be configured by the vendor to remove the previously-set cookie, in some embodiments.

Referring now to FIG. 5, a flowchart of an example embodiment of a process for operating an electronic device in a mobile advertising attribution system 100 disclosed herein is illustrated. In one embodiment, this process is embodied in one or more software programs stored in one or more memories and executed by one or more processors or servers, as described above. Although this process is described with reference to the flowchart illustrated in FIG. 5, it should be appreciated that many other methods of performing the acts associated with this process may be used. For example, the order of certain steps described may be changed, or certain steps described may be optional.

In one embodiment, the electronic device receives from the advertisement server 154 and/or the system 100 a mobile advertisement related to a mobile application as indicated in block 502 of FIG. 5. The mobile application is typically executable by the electronic device so that the mobile advertisement is intended to market the mobile application to a user of the electronic device. The mobile advertisement includes an advertisement identifier for uniquely identifying the mobile advertisement. The advertisement identifier can include identifiers for the advertising service and/or the product or service related to the mobile advertisement. The electronic device receives the mobile advertisement from the advertisement server 154 and/or the system 100 over a network using HTML, Flash, or other appropriate languages, protocols, and/or platforms. The electronic device displays the mobile advertisement to a user of the electronic device on a web page or within an application, for example. The content of the mobile advertisement includes text, graphics, video, sound, animation, and/or other elements, and can be arranged as a banner advertisement, text advertisement, full-screen advertisement, or other type of advertisement.

When the user interacts with the mobile advertisement, the advertisement identifier for the mobile advertisement is transmitted from the electronic device to the system 100, as indicated in block 504. The user interacts with the mobile advertisement by touching or clicking on the mobile advertisement on the electronic device, for example. In one embodiment, the advertisement identifier can be transmitted to the system 100 through URL query strings and parameters, such as through HTTP GET (e.g., transmitting the URL and a header), HTTP POST (e.g., transmitting a message body), and/or HTTP PUT requests, and/or through custom or proprietary protocols. This is in contrast to traditional interaction with a mobile advertisement related to a mobile application, which immediately directs the electronic device to an application store for downloading and installation of the mobile application.

The electronic device receives a cookie set request from the system 100, as indicated in block 506. The cookie set request causes the electronic device to set a cookie including an advertisement campaign identifier, the date and time, cookie attributes, and/or other information, as indicated in block 508. The cookie can be set in a browser on the electronic device and/or in a data store of the electronic device that is capable of storing, retrieving, and removing cookies without the use of a browser. In one embodiment, an application that implements behavior similar to a browser executes on the electronic device to store the cookie in the data store. The cookie set request can be formed as part of an HTTP response that requests the electronic device to set a name-value pair for each of the advertisement campaign identifier, the date and time, and/or other information. In one embodiment, the date and time includes the date and time the advertisement identifier was received by the system 100. In another embodiment, the date and time includes the date and time the cookie set request is being transmitted to the electronic device. The advertisement campaign identifier uniquely identifies an advertisement campaign that can include one or more mobile advertisements that are related to the same mobile application. Similarly, a mobile advertisement related to a mobile application can be included as part of one or more advertisement campaigns.

The cookie set request can request the electronic device to set cookie attributes including a cookie domain, a path, an expiration date and time, a maximum age, a Secure flag, and/or an HttpOnly flag. In particular, an expiration date and time or a maximum age can be transmitted in the cookie set request so that the cookie is a persistent cookie that will remain in the electronic device, in contrast to a session cookie that is deleted, such as after a browser is closed. In one embodiment, the cookie set request causes the electronic device to set the cookie as a background process so that the user of the electronic device does not visually see a browser opening if the browser was not already open, e.g., if the mobile advertisement was displayed in an application. In another embodiment, the cookie set request causes the electronic device to set the cookie such that the browser momentarily opens on the electronic device.

The electronic device receives a uniform resource locator (URL) for an application store 152 from the system 100, as indicated in block 510. The electronic device is redirected to the application store 152, as indicated in block 512, to download and install the mobile application related to the mobile advertisement that the user interacted with. The application store 152 includes, for example, the Apple App Store, Google Play, and other application stores. The URL for the application store 152 could cause the electronic device to execute a dedicated application for the mobile application store or to open a web page corresponding to the mobile application store. The user of the electronic device can download and install the mobile application, or can choose not to download and install the mobile application. Installing the mobile application includes granting the appropriate permissions to use the mobile application on the electronic device, in one embodiment. If the user chooses not to download and install the mobile application, the previously-set cookie will still remain on the electronic device.

If the user has downloaded and installed the mobile application, then upon initial execution of the mobile application, as indicated in block 514, the mobile application can invoke and execute the browser on the electronic device to retrieve the previously-set cookie, or cause another application to retrieve the cookie from the data store on the electronic device. The initial execution of the mobile application is the first-time use of the application on the electronic device. The electronic device can transmit the cookie and its associated data to the system 100, as indicated in block 516, such that the system 100 stores an attribution for the advertisement campaign based on the advertisement campaign identifier. The associated data in the cookie transmitted to the system 100 includes the advertisement campaign identifier, the date and time, and/or other information in the cookie. In one embodiment, the initial execution of the mobile application causes the electronic device to retrieve the cookie as a background process so that the user of the electronic device does not visually see the browser opening. In another embodiment, the initial execution of the mobile application causes the electronic device to retrieve the cookie such that the browser is momentarily seen on the electronic device. It should be noted that the mobile application is configured to retrieve the previously-set cookie upon initial execution by invoking and executing the browser and/or causing another application to retrieve the cookie from a data store. The vendor of the mobile application can configure the mobile application to perform this task.

In one embodiment, after the attribution is stored, the electronic device updates the status of the electronic device, such as by removing the previously-set cookie, marking the mobile application as used, and/or setting a dirty flag so that the electronic device does not cause the mobile application to access the cookie on later executions of the mobile application, as indicated in block 518. To remove the previously-set cookie, the electronic device can receive from the system 100 a cookie set request for the previously-set cookie with an expiration date prior to the current date and time. The electronic device can also receive as part of the cookie set request blank or different data for the previously-set name-value pairs in the cookie. In these cases, for example, the electronic device visits a URL on the system 100 that is only accessed when the mobile application is initially executed and in response, the system 100 transmits the cookie set request to remove the cookie, as described above. In one embodiment, to set a dirty flag in the mobile application, the electronic device can receive a request from the system 100 to the mobile application on the electronic device. In another embodiment, the mobile application can be previously configured by the vendor to set the dirty flag after an initial execution of the mobile application. The mobile application can also be configured by the vendor to remove the previously-set cookie, in some embodiments.

Referring now to FIG. 6, a flowchart of another example embodiment of a process for operating an electronic device in a mobile advertising attribution system 100 disclosed herein is illustrated. In one embodiment, this process is embodied in one or more software programs stored in one or more memories and executed by one or more processors or servers, as described above. Although this process is described with reference to the flowchart illustrated in FIG. 6, it should be appreciated that many other methods of performing the acts associated with this process may be used. For example, the order of certain steps described may be changed, or certain steps described may be optional.

In one embodiment, the electronic device receives from the advertisement server 154 and/or the system 100 a mobile advertisement related to a mobile application as indicated in block 602 of FIG. 6. The mobile application is typically executable by the electronic device so that the mobile advertisement is intended to market the mobile application to a user of the electronic device. The mobile advertisement includes an advertisement identifier for uniquely identifying the mobile advertisement. The advertisement identifier can include identifiers for the advertising service and/or the product or service related to the mobile advertisement. The electronic device receives the mobile advertisement from the advertisement server 154 and/or the system 100 over a network using HTML, Flash, or other appropriate languages, protocols, and/or platforms. The electronic device displays the mobile advertisement to a user of the electronic device on a web page or within an application, for example. The content of the mobile advertisement includes text, graphics, video, sound, animation, and/or other elements, and can be arranged as a banner advertisement, text advertisement, full-screen advertisement, or other type of advertisement.

When the user interacts with the mobile advertisement, the advertisement identifier for the mobile advertisement is transmitted from the electronic device to the system 100, as indicated in block 604. The user interacts with the mobile advertisement by touching or cocking on the mobile advertisement on the electronic device, for example. In one embodiment, the advertisement identifier can be transmitted to the system 100 through URL query strings and parameters, such as through HTTP GET (e.g., transmitting the URL and a header), HTTP POST (e.g., transmitting a message body), and/or HTTP PUT requests, and/or through custom or proprietary protocols. This is in contrast to traditional interaction with a mobile advertisement related to a mobile application, which immediately directs the electronic device to an application store for downloading and installation of the mobile application.

The electronic device determines an advertisement campaign identifier, as indicated in block 606. The advertisement campaign identifier uniquely identifies an advertisement campaign that can include one or more mobile advertisements that are related to the same mobile application. Similarly, a mobile advertisement related to a mobile application can be included as part of one or more advertisement campaigns. In one embodiment, the advertisement campaign identifier can be derived from the advertisement identifier by the electronic device. In another embodiment, the electronic device can receive the advertisement campaign identifier from the system 100 after the advertisement identifier is transmitted to the system 100.

The electronic device sets a cookie including the advertisement campaign identifier, the date and time, cookie attributes, and/or other information, as indicated in block 608. The cookie can be set in a browser on the electronic device and/or in a data store of the electronic device that is capable of storing, retrieving, and removing cookies without the use of a browser. In one embodiment, an application that implements behavior similar to a browser executes on the electronic device to store the cookie in the data store. In another embodiment, the electronic device could set the cookie using client-side scripting, such as through JavaScript. The electronic device receives such a script from the advertisement server 154 and/or the system 100 as part of the mobile advertisement received previously, such that the script sets the cookie in the same domain or a sub-domain.

The electronic device can also set cookie attributes including a cookie domain, a path, an expiration date and time, a maximum age, a Secure flag, and/or an HttpOnly flag. In particular, an expiration date and time or a maximum age can be set so that the cookie is a persistent cookie that will remain in the electronic device, in contrast to a session cookie that is deleted, such as after a browser is closed. In one embodiment, the electronic device sets the cookie as a background process so that the user of the electronic device does not visually see a browser opening if the browser was not already open, e.g., if the mobile advertisement was displayed in an application. In another embodiment, the electronic device sets the cookie such that the browser momentarily opens on the electronic device.

The electronic device can be redirected to an application store 152 from the system 100, as indicated in block 610, by visiting a URL for the application store 152. The URL for the application store 152 is received from the system 100 or is included as part of the client-side scripting, as described above. The electronic device is redirected to the application store 152 to download and install the mobile application related to the mobile advertisement that the user interacted with. The application store 152 includes, for example, the Apple App Store, Google Play, and other application stores. The URL for the application store 152 could cause the electronic device to execute a dedicated application for the mobile application store or to open a web page corresponding to the mobile application store. The user of the electronic device can download and install the mobile application, or can choose not to download and install the mobile application. Installing the mobile application includes granting the appropriate permissions to use the mobile application on the electronic device, in one embodiment. If the user chooses not to download and install the mobile application, the previously-set cookie will still remain on the electronic device.

If the user has downloaded and installed the mobile application, then upon initial execution of the mobile application, as indicated in block 612, the mobile application can invoke and execute the browser on the electronic device to retrieve the previously-set cookie, or cause another application to retrieve the cookie from the data store on the electronic device. The initial execution of the mobile application is the first-time use of the application on the electronic device. The electronic device can transmit the cookie and its associated data to the system 100, as indicated in block 614, such that the system 100 stores an attribution for the advertisement campaign based on the advertisement campaign identifier. The associated data in the cookie transmitted to the system 100 includes the advertisement campaign identifier, the date and time, and/or other information in the cookie. In one embodiment, the initial execution of the mobile application causes the electronic device to retrieve the cookie as a background process so that the user of the electronic device does not visually see the browser opening. In another embodiment, the initial execution of the mobile application causes the electronic device to retrieve the cookie such that the browser is momentarily seen on the electronic device. It should be noted that the mobile application is configured to retrieve the previously-set cookie upon initial execution by invoking and executing the browser and/or causing another application to retrieve the cookie from a data store. The vendor of the mobile application can configure the mobile application to perform this task.

In one embodiment, after the attribution is stored, the electronic device updates the status of the electronic device, such as by removing the previously-set cookie, marking the mobile application as used, and/or by setting a dirty flag so that the electronic device does not cause the mobile application to access the cookie on later executions of the mobile application, as indicated in block 616. To remove the previously-set cookie, the electronic device can receive from the system 100 a cookie set request for the previously-set cookie with an expiration date prior to the current date and time. The electronic device can also receive as part of the cookie set request blank or different data for the previously-set name-value pairs in the cookie. In these cases, for example, the electronic device visits a URL on the system 100 that is only accessed when the mobile application is initially executed and in response, the system 100 transmits the cookie set request to remove the cookie, as described above. In one embodiment, to set a dirty flag in the mobile application, the electronic device can receive a request from the system 100 to the mobile application on the electronic device. In another embodiment, the mobile application can be previously configured by the vendor to set the dirty flag after an initial execution of the mobile application. The mobile application can also be configured by the vendor to remove the previously-set cookie, in some embodiments.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of operating an electronic device, said method comprising:
(a) transmitting from the electronic device to at least one server an advertisement identifier associated with a mobile advertisement, the mobile advertisement related to a mobile application capable of executing on the electronic device;
(b) receiving from the at least one server at the electronic device a cookie set request including an advertisement campaign identifier that uniquely identifies an advertisement campaign including the mobile advertisement;
(c) setting a cookie on the electronic device, the cookie including the advertisement campaign identifier, in response to receiving the cookie set request;
(d) receiving from the at least one server at the electronic device a URL for a mobile application store;
(e) redirecting the electronic device to the mobile application store, in response to receiving the URL; and
(f) transmitting from the electronic device to the at least one server the cookie including the advertisement campaign identifier such that the at least one server is caused to store an attribution for the advertisement campaign.

2. The method of claim 1, wherein:
the cookie set request includes a date and time of when the advertisement identifier is transmitted; and
setting the cookie includes setting the cookie on the electronic device, the cookie including the date and time, in response to receiving the cookie set request.

3. The method of claim 2, wherein transmitting the cookie includes transmitting from the electronic device to the at least one server the cookie including the date and time.

4. The method of claim 1, wherein transmitting the cookie includes transmitting from the electronic device to the at least one server the cookie such that the at least one server is caused to store the advertisement campaign identifier and a date and time of when the advertisement identifier is received at the at least one server.

5. The method of claim 1, which includes receiving from the at least one server at the electronic device the mobile advertisement, wherein the mobile advertisement includes the advertisement identifier.

6. The method of claim 1:
which includes initially executing the mobile application on the electronic device; and
wherein transmitting the cookie includes transmitting from the electronic device to the at least one server the cookie, in response to initially executing the mobile application.

7. The method of claim 6, which includes removing the cookie on the electronic device, in response to initially executing the mobile application on the electronic device.

8. The method of claim 1, wherein:
the cookie set request includes a cookie attribute including one or more of a cookie domain, a path, an expiration date and time, a maximum age, a Secure flag, or an HttpOnly flag; and
setting the cookie includes setting the cookie on the electronic device, the cookie including the cookie attribute, in response to receiving the cookie set request.

9. The method of claim 1, wherein transmitting the cookie includes transmitting from the electronic device to the at least one server the cookie including a plurality of advertisement campaign identifiers such that the at least one server is caused to store the attribution for one or more of a plurality of advertisement campaigns, wherein the plurality of advertisement campaign identifiers respectively uniquely identify the plurality of advertisement campaigns.

10. The method of claim 1, wherein setting the cookie includes setting the cookie on the electronic device in one or more of a browser of the electronic device or a data store of the electronic device.

11. An electronic device, comprising:
at least one memory device; and
at least one processor, the at least one processor configured to operate with the at east one memory device and at least one server to:
(a) transmit to the at least one server an advertisement identifier associated with a mobile advertisement, the mobile advertisement related to a mobile application capable of executing on the electronic device;
(b) receive from the at least one server a cookie set request including an advertisement campaign identifier that uniquely identifies an advertisement campaign including the mobile advertisement;
(c) set a cookie including the advertisement campaign identifier, in response to receiving the cookie set request;
(d) receive from the at least one server a URL for a mobile application store;
(e) redirect to the mobile application share, in response to receiving the URL; and
(f) transmit to the at least one server the cookie including the advertisement campaign identifier such that the at least one server is caused to store an attribution for the advertisement campaign.

12. The electronic device of claim 11, wherein:
the cookie set request includes a date and time of when the advertisement identifier is transmitted; and
the at least one processor is configured to operate with the at least one memory device and the at least one server to set the cookie by setting the cookie including the date and time, in response to receiving the cookie set request.

13. The electronic device of claim 12, wherein the at least one processor is configured to operate with the at least one memory device and the at least one server to transmit the cookie by transmitting to the at least one server the cookie including the date and time.

14. The electronic device of claim 11, wherein the at least one processor is configured to operate with the at least one memory device and the at least one server to transmit the cookie by transmitting to the at least one server the cookie such that the at least one server is caused to store the advertisement campaign identifier and a date and time of when the advertisement identifier is received at the at least one server.

15. The electronic device of claim 11, wherein the at least one processor is configured to operate with the at least one memory device and the at least one server to receive from the at least one server the mobile advertisement, wherein the mobile advertisement includes the advertisement identifier.

16. The electronic device of claim 11, wherein the at least one processor is configured to operate with the at least one memory device and the at least one server to:
initially execute the mobile application on the electronic device; and
transmit the cookie by transmitting to the at least one server the cookie, in response to initially executing the mobile application.

17. The electronic device of claim 16, wherein the at least one processor is configured to operate with the at least one memory device and the at least one server to remove the cookie, in response to initially executing the mobile application.

18. The electronic device of claim 11, wherein:
the cookie set request includes a cookie attribute including one or more of a cookie domain, a path, an expiration date and time, a maximum age, a Secure flag, or an HttpOnly flag; and
the at least one processor is configured to operate with the at least one memory device and the at least one server to set the cookie by setting the cookie including the cookie attribute, in response to receiving the cookie set request.

19. The electronic device of claim 11, wherein the at least one processor is configured to operate with the at least one memory device and the at least one server to transmit the cookie by transmitting to the at least one server the cookie including a plurality of advertisement campaign identifiers such that the at least one server is caused to store the attribution for one or more of a plurality of advertisement campaigns, wherein the plurality of advertisement campaign identifiers respectively uniquely identify the plurality of advertisement campaigns.

20. The electronic device of claim 11, wherein the at least one processor is configured to operate with the at least one memory device and the at least one server to set the cookie by setting the cookie in one or more of a browser of the electronic device or a data store of the electronic device.

21. A method of operating an electronic device, said method comprising:
(a) transmitting from the electronic device to at least one server an advertisement identifier associated with a mobile advertisement, the mobile advertisement related to a mobile application capable of executing on the electronic device;
(b) causing the electronic device to determine an advertisement campaign identifier associated with the advertisement identifier, wherein the advertisement campaign identifier uniquely identifies an advertisement campaign including the mobile advertisement;
(c) setting a cookie on the electronic device, the cookie including the advertisement campaign identifier;
(d) redirecting the electronic device to a mobile application store; and
(e) transmitting from the electronic device to the at least one server the cookie including the advertisement campaign identifier such that the at least one server is caused to store an attribution for the advertisement campaign.

22. The method of claim 21, wherein setting the cookie includes setting the cookie on the electronic device, the cookie including a date and time of when the advertisement identifier is transmitted.

23. The method of claim 22, wherein transmitting the cookie includes transmitting from the electronic device to the at least one server the cookie including the date and time.

24. The method of claim 21, wherein transmitting the cookie includes transmitting from the electronic device to the at least one server the cookie such that the at least one server is caused to store the advertisement campaign identifier and a date and time of when the advertisement identifier is received at the at least one server.

25. The method of claim 21, which includes receiving from the at least one server at the electronic device the mobile advertisement, wherein the mobile advertisement includes the advertisement identifier.

26. The method of claim 21:
which includes initially executing the mobile application on the electronic device; and
wherein transmitting the cookie includes transmitting from the electronic device to the at least one server the cookie, in response to initially executing the mobile application.

27. The method of claim 26, which includes removing the cookie on the electronic device, in response to initially executing the mobile application on the electronic device.

28. The method of claim 21, wherein setting the cookie includes setting the cookie on the electronic device, the cookie including a cookie attribute including one or more of a cookie domain, a path, an expiration date and time, a maximum age, a Secure flag, or an HttpOnly flag.

29. The method of claim 21, wherein transmitting the cookie includes transmitting from the electronic device to the at least one server the cookie including a plurality of advertisement campaign identifiers such that the at least one server is caused to store the attribution for one or more of a plurality of advertisement campaigns, wherein the plurality of advertisement campaign identifiers respectively uniquely identify the plurality of advertisement campaigns.

30. The method of claim 21, wherein setting the cookie includes setting the cookie on the electronic device in one or more of a browser of the electronic device or a data store of the electronic device.

31. The method of claim 21, wherein causing the electronic device to determine the advertisement campaign identifier includes causing the electronic device to derive the advertisement campaign identifier from the advertisement identifier.

32. The method of claim 21, wherein causing the electronic device to determine the advertisement campaign identifier includes receiving from the at least one server at the electronic device the advertisement campaign identifier.

33. An electronic device, comprising:
at least one memory device; and
at least one processor, the at least one processor configured to operate with the at east one memory device and at least one server to:
(a) transmit to the at least one server an advertisement identifier associated with a mobile advertisement, the mobile advertisement related to a mobile application capable of executing on the electronic device;
(b) determine an advertisement campaign identifier associated with the advertisement identifier, wherein the advertisement campaign identifier uniquely identifies an advertisement campaign including the mobile advertisement;
(c) set a cookie including the advertisement campaign identifier;
(d) redirect to a mobile application store; and
(e) transmit to the at least one server the cookie including the advertisement campaign identifier such that the at least one server is caused to store an attribution for the advertisement campaign.

34. The electronic device of claim 33, wherein the at least one processor is configured to operate with the at least one memory device and the at least one server to set the cookie by setting the cookie including a date and time of when the advertisement identifier is transmitted.

35. The electronic device of claim 34, wherein the at least one processor is configured to operate with the at least one memory device and the at least one server to transmit the cookie by transmitting to the at least one server the cookie including the date and time.

36. The electronic device of claim 33, wherein the at least one processor is configured to operate with the at least one memory device and the at least one server to transmit the cookie by transmitting to the at least one server the cookie such that the at least one server is caused to store the advertisement campaign identifier and a date and time of when the advertisement identifier is received at the at least one server.

37. The electronic device of claim 33, wherein the at least one processor is configured to operate with the at least one memory device and the at least one server to receive from the at least one server the mobile advertisement, wherein the mobile advertisement includes the advertisement identifier.

38. The electronic device of claim 33, wherein the at least one processor is configured to operate with the at least one memory device and the at least one server to:
initially execute the mobile application on the electronic device; and
transmit the cookie by transmitting to the at least one server the cookie, in response to initially executing the mobile application.

39. The electronic device of claim 38, wherein the at least one processor is configured to operate with the at least one memory device and the at least one server to remove the cookie, in response to initially executing the mobile application.

40. The electronic device of claim 33, wherein the at least one processor is configured to operate with the at least one memory device and the at least one server to set the cookie by setting the cookie including a cookie attribute including one or more of a cookie domain, a path, an expiration date and time, a maximum age, a Secure flag, or an HttpOnly flag.

41. The electronic device of claim 33, wherein the at least one processor is configured to operate with the at least one memory device and the at least one server to transmit the cookie by transmitting to the at least one server the cookie including a plurality of advertisement campaign identifiers such that the at least one server is caused to store the attribution for one or more of a plurality of advertisement campaigns, wherein the plurality of advertisement campaign identifiers respectively uniquely identify the plurality of advertisement campaigns.

42. The electronic device of claim 33, wherein the at least one processor is configured to operate with the at least one memory device and the at least one server to set the cookie by setting the cookie in one or more of a browser of the electronic device or a data store of the electronic device.

43. The electronic device of claim 33, wherein the at least one processor is configured to operate with the at least one memory device and the at least one server to determine the advertisement campaign identifier by deriving the advertisement campaign identifier from the advertisement identifier.

44. The electronic device of claim 33, wherein the at east one processor is configured to operate with the at least one memory device and the at least one server to determine the advertisement campaign identifier by receiving from the at least one server the advertisement campaign identifier.
